(19) United States
(12) Patent Application Publication
(10) Pub. No.: US 2011/0094084 A1
(43) Pub. Date: Apr. 28, 2011

(54) CONNECTING DEVICE AND METHOD FOR CREATING A SCREW CONNECTION

(76) Inventor: Stefan Hilleke, Neuenrade (DE)

(21) Appl. No.: 12/863,052

(22) PCT Filed: Jan. 15, 2009
(86) PCT No.: PCT/EP09/00223

§ 371 Date: Jan. 14, 2011

(30) Foreign Application Priority Data
Jan. 15, 2008 (DE) 20 2008 000 574.4

(51) Int. Cl. F16B 29/00; B23P 11/00

(52) U.S. Cl. 29/525.11; 411/360

(57) ABSTRACT

The invention relates to connecting device (27) comprising a screw (1) and a carrier (7, 70), the latter being provided with a hollow space (8, 9, 28, 29) for receiving therein said screw (1), said hollow space (8, 9, 28, 29) being in frictional and/or positive engagement with the thread (3) of the screw (1) upon insertion of said screw (1). The hollow space (8, 9, 28, 29) is provided with a membrane (11) which can be penetrated by the screw (1) and which is arranged substantially transversely to the longitudinal screw axis (Y), said membrane (11) forming a skirt (15), which encloses primarily the thread (3) at least partially, while undergoing deformation during insertion of the screw (1). The invention further relates to a method for creating a screw connection by inserting a screw (1) into a carrier (7, 70).

The invention relates to a connecting device comprising a screw and a carrier according to the preamble of the main claim and a method for creating a screw connection.

A large number of such connecting devices is known in practice, e.g. for fixing solar panels on carrier structures or for use in frame-and-body construction in the automotive industry.

German patent application DE 10 2005 053 875 A1 discloses a screw connection between a bearing of an auxiliary frame and a tubular carrier of the body of a motor vehicle. A reinforcement element is arranged within a longitudinal carrier member, said reinforcement element and said carrier element being provided with holes in such a way that a bearing sleeve can be inserted, said bearing sleeve being fixed in the area of the holes. The bearing sleeve has arranged therein an internal thread, which is provided at the end facing away from the point of contact between the bearing and the support. The screw connection thus achieves an improved rigidity and stability.

The above-described screw connection is disadvantageous insofar as an additional component, viz. the bearing sleeve, must be installed in the longitudinal carrier member in a further assembly operation. Moreover, prior to inserting the bearing sleeve, an additional boring operation has to be carried out in the longitudinal support member. Furthermore, the bearing sleeve according to the teaching of the above-mentioned patent application necessitates a precut thread, and this requires another step in the manufacturing process. Hence, the production of the above-mentioned screw connection is comparatively complicated and it is cost intensive.

The prior art also discloses a great variety of profile sections having formed therein preformed screw channels which are adapted to receive screws therein. Such profile sections are disadvantageous insofar as, in some fields of use, the support structures of the profile sections are placed onto an uneven substrate and a precise orientation of the profile sections is therefore difficult to accomplish. Hence, it requires a lot of time to bring the screw, the component to be mounted, and the profile section into alignment with one another before the screw is fastened.

It is the object of the present invention to provide a connecting device of the type in question and a method for creating a screw connection, so that a reliable, easily and swiftly mountable and economically efficient connection can be established between a screw and a carrier.

This object is achieved by a connecting device according to the features of claim 1 and a method according to claim 35.

The connecting device according to the present invention comprises a screw and a carrier, said carrier being provided with a hollow space for receiving therein the screw. When said screw is being screwed into the hollow space, it comes into engagement with the walls delimiting the hollow space. In order to prevent a deformation of the walls of the hollow space, which would entail a deterioration of screw engagement, the hollow space has inserted therein a membrane which is arranged substantially transversely to the longitudinal screw axis and which stabilizes the desired geometrical shape of the hollow space. During insertion of the screw, the membrane is penetrated by the latter, whereby deformed material is displaced upwards and/or downwards with respect to the longitudinal screw axis and a skirt is thus formed, which encloses primarily the thread of the screw at least partially and which improves the engagement between the screw and the carrier still further. The skirt is formed by the material of the membrane which is displaced upwards and/or downwards due to insertion of the screw and which, supported by the walls of the hollow space and/or additional portions of the carrier, defines a portion of the thread convolutions formed in the carrier. This portion of the thread convolutions formed is in very close contact with the thread of the screw and contributes significantly to securing the latter in position.

The term “upper” refers to the side of the connecting device located closer to the head of the screw and the term “lower” refers to the side of the connecting device located closer to the tip of the screw.

The structural design of the carrier and of the screw according to the present invention makes the use of a counter nut or of a preformed thread in the carrier superfluous.

The carrier with the hollow space and the membrane can especially be implemented as an integral component. When the material used is metal, it will be advantageous to implement the carrier e.g. as a profile section; when plastic is used as a material for the carrier, the use of an injection moulding process will be of advantage.

The carrier comprises a bearing surface which is arranged substantially at right angles to the longitudinal screw axis, wherein the head of the screw or an assembly part, that is indirectly or directly secured in position between the head of the screw and the carrier by frictional engagement, is in contact with said bearing surface. The hollow space opens into the bearing surface so as to allow easy insertion of the screw into said hollow space. The diameter d of the hollow space can be varied along the longitudinal screw axis, such variation of diameter being possible in the case of opposed sidewalls of the hollow space as well as in the case of a largely cylindrical shape of the hollow space. The diameter of the hollow space is varied along the longitudinal screw axis Y in such a way that the hollow space has the largest diameter at the opening of the carrier on the side of the bearing surface and/or in the area of the hollow space close to the membrane, whereas the smallest diameter of the hollow space occurs between these areas in the direction of the longitudinal screw axis.

The variation of diameter can especially be accomplished by designing a concave sidewall; this can be achieved either by increasing the thickness of the sidewall in a certain area or by providing a curved sidewall. The essential feature in this respect is that, in a central area of the hollow space, a smaller diameter/distance is provided between the sidewalls. It is thus possible to achieve a better contact between the thread convolutions formed in the hollow space and the thread of the screw, since the thus formed sidewalls of the hollow space allow a higher counter pressure to be applied to the screw during screwing in. Furthermore, when the screw is tightened firmly and when an upwardly directed high force therefore occurs in the area of the skirt, the sidewalls can be prevented from buckling, and it is even possible to achieve an effect to the contrary, viz. a self-reinforcing narrowing of the sidewalls onto the thread.

The smallest diameter d of the hollow space at right angles to the longitudinal screw axis can be smaller than the external diameter Da of the thread of the screw. The term “diameter” may refer to the diameter of a substantially cylindrical hollow space as well as to the distance between two sidewalls of a hollow space, especially when the carrier is implemented as a profile section and when the screw is in engagement with two sidewalls of the hollow space which extend substantially in parallel. Due to the fact that, at right angles to the longitudinal screw axis, the smallest diameter d of the hollow space is larger than the core diameter Di of the thread, a thread can easily be formed in the hollow space by a forming/cutting effect of the screw according to an embodiment of the present invention.

When the carrier is implemented as a profile section, the hollow space defines within the carrier a channel in the longitudinal direction of said profile section, whereby arbitrary positioning of the screws in the longitudinal direction of the profile section will be allowed, thus providing a large number of fastening possibilities and, consequently, a geometrically very flexible connecting device. A screw can thus also be arranged at a slightly oblique position within the hollow space and it can be inserted along the whole length of the channel. It follows that, within a certain tolerance range, it will no longer be necessary to precisely align the screw so as to obtain a reliable connection, and the screw can be inserted at an arbitrary position along the profile section, whereby the mounting speed of the connecting device will be increased many times over. This applies especially to cases of use like the application of solar panels to roof structures, since it is here very difficult to precisely align the carriers relative to one another because they are fixed to a common rooftop offering only a very imprecise mounting surface.

According to a preferred embodiment, the hollow space comprises in particular two sidewalls, the membrane, which is arranged substantially at right angles to the sidewalls, connecting said sidewalls, i.e. it geometrically stabilizes the hollow space and allows the thread structure to be easily formed in the hollow space. The sidewalls are essentially spaced apart at the distance d, which has already been defined hereinbefore; in this embodiment, the distance does not refer to a diameter, but to a substantially parallel spacing of the sidewalls. The carrier can have hollow spaces on several sides, said hollow spaces being arranged preferably at right angles to one another. The connecting device according to the present invention thus offers fastening possibilities on several sides.

In order to allow a high strength and stability of the connecting device, it will be particularly advantageous when the material used for the screw has a higher strength than the material used for the carrier. This also allows an improvement of thread formation during the forming/cutting engagement of the screw with the carrier when the screw is being screwed in. The screw tip can especially be implemented such that a uniform deformation resistance can be caused when the screw is being driven through the membrane, so that a comparatively uniform torque will be necessary for screwing the screw into the membrane, whereby it will be possible to execute the screwing-in operation more ergonomically.

According to a preferred embodiment of the present invention, the thread of the screw tip is in particular conical in shape so as to allow easier engagement with the membrane. A thread-forming screw with a forming tip allows the walls of the hollow space to be easily deformed into thread convolutions without any chip removal. In addition, the forming tip can allow the screw to penetrate the membrane in a deforming fashion so that chip removal will be avoided in this case as well. According to another preferred embodiment, the screw may, however, also have a cutting tip, so that the screw will form a thread in the walls of the hollow space and in the membrane in a chip-removing mode. In order to prevent the screw from being blocked by removed chips, a recess, which may in particular adjoin the cutting edge, can be provided for receiving chips therein.

In order to stabilize the screw also beyond the membrane and guarantee gripping of the screw in the carrier, an elongation leg can project beyond the membrane substantially in the direction of the longitudinal screw axis on one side. In the case of a cylindrical hollow space, the elongation leg may especially have a cylindrical shape, and in the case of a hollow space having substantially parallel sidewalls, two substantially parallel elongation legs project beyond the membrane in the direction of the longitudinal screw axis. The elongation legs especially make it possible to increase the maximum torque that can be applied to the screw at least in a direction orthogonal to the longitudinal screw axis, to increase the resistance of the screw to tearing in the direction of the longitudinal screw axis as well as the resistance to unintentional loosening of the screw.

At the end of the elongation legs, said elongation legs can by provided with at least one inwardly directed projection; in the case of a cylindrical hollow space, said projection represents a disk secured to the elongation legs on its outermost radius, said disk having a concentric opening at the centre. In the case of a hollow space having substantially parallel sidewalls, said hollow space may have two projections, which are oriented towards one another and which are arranged substantially in the plane extending at right angles to the longitudinal screw axis. The projections additionally engage the thread of the inserted screw thus securing the latter against tearing along the longitudinal screw axis and against loosening.

In addition, when the projections are forced outwards by the screw, the sidewalls of the hollow space will be forced inwards about the fulcrum defined by the membrane, so that the engagement of the thread of the screw in the thread convolutions of the sidewall of the hollow space will additionally be secured.

The elongation leg may enclose, at least partially, the skirt which has been produced by the screw passing through the membrane, so that the thread formed in the hollow space is held in tight engagement with the screw, thus allowing a safe connection between the screw and the carrier.

For obtaining a safe connection, the thread of the screw should be located at least on the level of the membrane in the inserted condition of the screw.

According to a preferred embodiment, the membrane can be substantially flat prior to undergoing deformation, the height of the membrane in the direction of the longitudinal screw axis being smaller than the membrane dimensions at right angles to the longitudinal screw axis. According to another preferred embodiment, the membrane may be substantially funnel shaped prior to undergoing deformation in the section penetrated by the screw, so as to facilitate the forming of the thread in the membrane. Easier insertion of the screw through the membrane and improved thread forming can be accomplished by providing the membrane at least one location thereof with a reduced thickness allowing easy gripping of the screw in and penetration of the screw through the membrane. For the same purpose, the membrane may also be provided with an opening and/or a longitudinal cut at least one location thereof, whereby the torque required for passing the screw through the membrane can be reduced still further.

When the carrier is implemented as a profile section, a longitudinal notch in the middle of the membrane along the longitudinal direction of the profile section can improve the effect of the membrane as a fulcrum for the projections, since this location of reduced material thickness allows easy deformation of the membrane.

The connecting device can be configured such that at least one assembly part is indirectly or directly in engagement between a screw head of the screw and the carrier; the indirect connection can be accomplished via a cover rail comprising at least one screw head contact surface and one assembly part contact surface. The screw head contact surface is in contact with a screw head of the screw, and the assembly part contact surface is in contact with the assembly part to be secured in position.

According to an advantageous embodiment, a screw-insertion channel can be arranged in the carrier of the connecting device above the hollow space. The screw-insertion channel is provided with projections defining an opening having a diameter which is larger than the diameter of the hollow space. It is thus possible to selectively use the screw-insertion channel or the hollow space for connecting assembly parts to the carrier. A connection via the screw-insertion channel allows a high precision of fastening, whereas a connection via the hollow space makes it possible to establish the connection more rapidly. The projections serve as a counter bearing and provide the possibility of screwing in screws, which are intended to be used for insertion in the hollow space, without said screws coming unintentionally into contact with the projections of the screw-insertion channel.

The screw-insertion channel can have inserted therein a slot nut having a thread. A screw can be screwed into this thread so that a connection can be established. The slot nut thus forms a reliable counter bearing for various types of screws.

Alternatively, the head of a screw can be inserted into the screw-insertion channel, the thread of said screw projecting beyond the carrier. This screw can have attached thereto a nut so as to fix assembly parts to the carrier.

In addition, the cover rail may comprise an opening for passing the screw therethrough, and this opening may especially be provided with a chamfer on its sidewall, so that a suitably shaped screw head can be countersunk such that it is flush with the surface of the cover rail. In addition, the cover rail may be provided with a flange bordering on at least one assembly part to be fixed in position and allowing thus reliable mounting in a direction at right angles to the longitudinal screw axis.

The cover rail can be in engagement with at least two assembly parts to be secured in position, at least one of the assembly parts to be secured in position bordering on one of the two sides of the flange. The assembly part contact surface of the cover rail may advantageously have provided thereon means for increasing the maximum transmittable friction force, in particular a plurality of small peaked projections, or a rough surface structure, which can indent themselves/itself in the assembly part to be fixed in position and thus secure the latter against displacement. The assembly parts may e.g. be solar panels.

The screw can have a screw head which is bevelled on the lower side thereof so as to allow optimum engagement with the cover rail. In addition, the screw may have a screw head comprising a head rest portion for applying the clamping force of the screw indirectly or directly to the assembly part, and further comprising a tool engagement portion; the latter can be configured such that it can be separated from the head rest portion. It is thus possible to accomplish an anti-theft effect for the assembly part secured in position by the connecting device, since, without the tool engagement portion on its head rest portion, which can especially be countersunk in a cover rail, the screw head does not have any tool engagement means whatsoever.

The screw head is especially configured such that the tool engagement portion will shear off from the head rest portion, when the torque applied thereto exceeds a specific value. Said shearing off is especially made possible by a groove provided in the screw head between the head rest portion and the tool engagement portion. According to a preferred embodiment of the present invention, the torque in response to which the tool engagement portion will shear off from the head rest portion is smaller than the torque in response to which the screw will be torn from the carrier and higher than the torque which has to be applied to the screw for causing it to penetrate the membrane.

In the following, preferred embodiments of the connecting device according to the present invention will be described on the basis of the figures, in which:

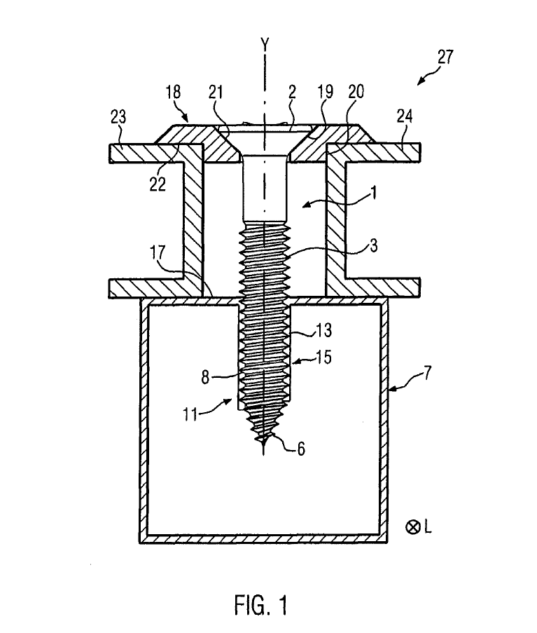

FIG. 1 shows a first embodiment of the present invention as a sectional view of a carrier, two assembly parts and a cover rail, which are connected by means of a screw.

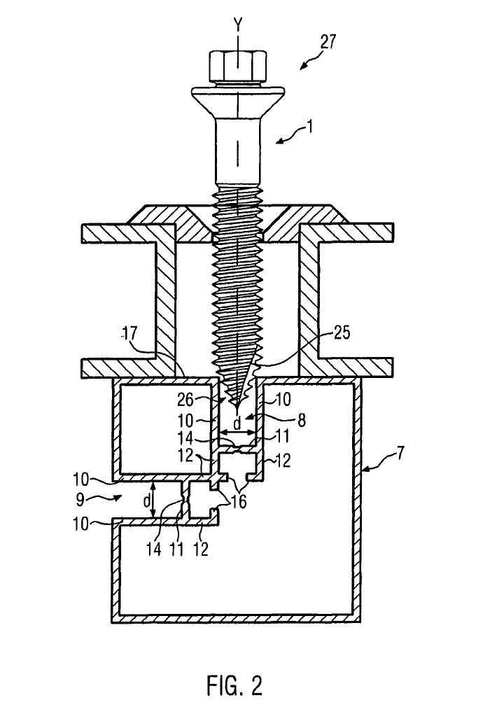

FIG. 2 shows a second embodiment of the present invention, with the screw in a non-inserted condition, the screw being here provided with a cutting edge, and the carrier being provided with hollow spaces on two of its lateral surfaces.

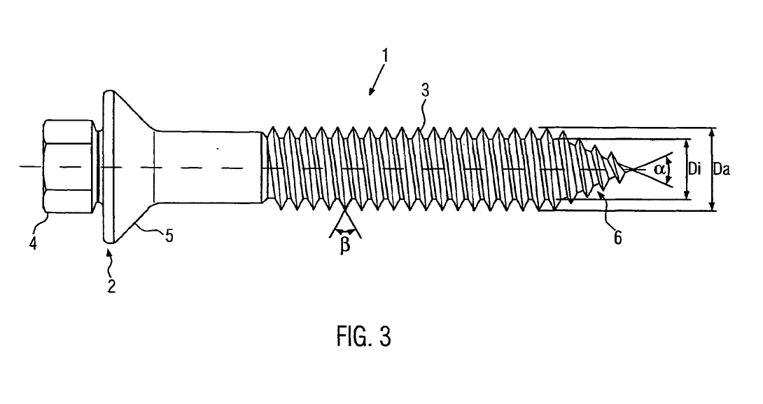

FIG. 3 shows a side view of a screw for use in the connecting device according to the present invention.

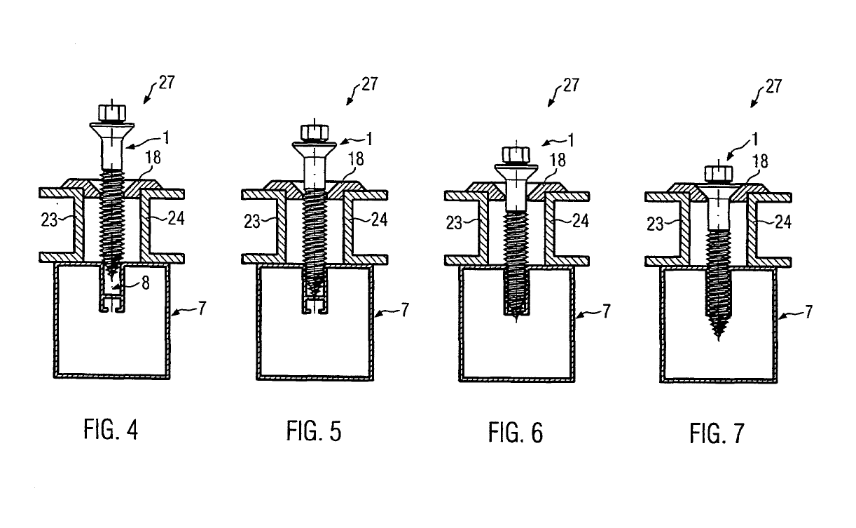

FIG. 4 to FIG. 7 show, in the form of a sequence of pictures, the insertion of the screw into the connecting device of the first embodiment according to the present invention.

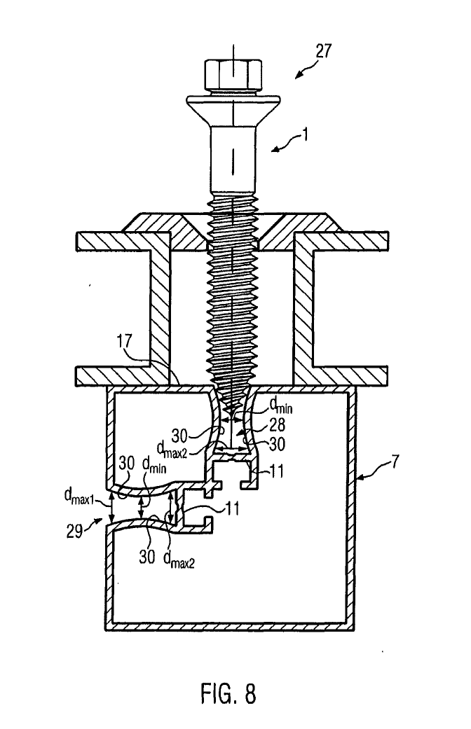

FIG. 8 shows a sectional view of a third embodiment of the present invention, with a carrier having a modified hollow space geometry.

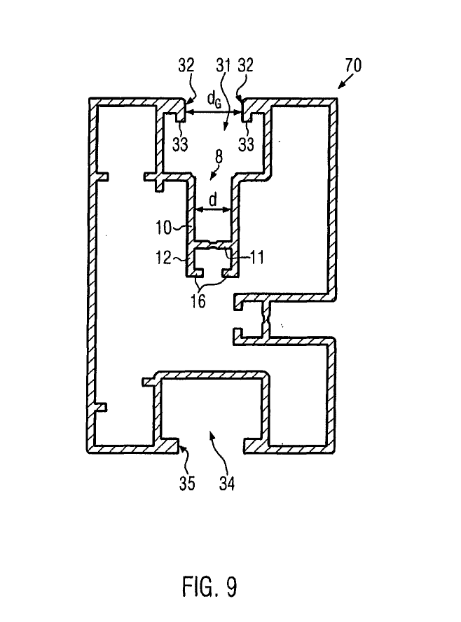

FIG. 9 shows a sectional view of a fourth embodiment of the present invention, with a carrier provided with additional screw-insertion channels.

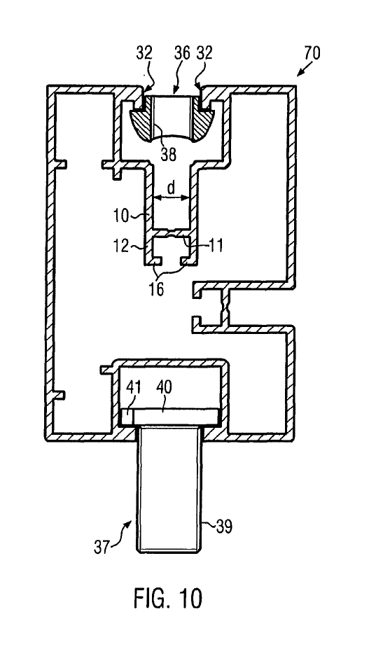

FIG. 10 shows the fourth embodiment according to FIG. 9, with an inserted slot nut and a hammer head screw.

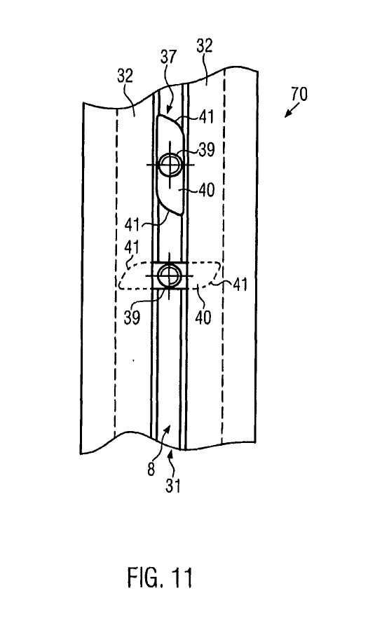

FIG. 11 shows a top view of the carrier of the fourth embodiment according to FIG. 9 during insertion of the hammer head screw.

FIG. 1 shows a first embodiment of the connecting device 27 according to the present invention. In this first embodiment, the screw has been fully screwed into the hollow space 8 and defines thread convolutions 13 with the walls of the latter. In the area of the membrane 11 (cf. FIG. 2) a skirt 15 is formed by the screw passing through said membrane, said skirt 15 forming part of the thread convolutions 13. The carrier 7 is implemented as a profile section and has a substantially uniform cross-section along its longitudinal direction L, which extends orthogonally to the plane of the drawing. The screw has a longitudinal axis Y which extends substantially at right angles to a bearing surface 17. The bearing surface 17 has arranged thereon two assembly parts 23, 24 which are in frictional engagement with said bearing surface 17. In order to provide the necessary force for said frictional engagement, a cover rail 18 engages each of said assembly parts 23, 24 with an assembly part contact surface 22. The cover rail 18 is provided with a screw head contact surface 21 allowing a transmission of force from the screw 1 to the cover rail 18. The screw 1 is passed through an opening 19 of the cover rail 18. In addition, said cover rail 18 comprises a flange 20 bordering on the assembly parts 23, 24 in such a way that, during the screwing operation and in the screw-fastened state of the connecting device 27, said flange 20 will be able to additionally secure the assembly parts 23, 24 in position in at least a direction orthogonal to the longitudinal screw axis Y. In the present embodiment of the invention, the screw head 2 is substantially flush with the cover rail 18 and the thread 3 of the screw 1 extends over the entire length of the hollow space 8. The screw tip 6 projects beyond the hollow space 8 and the elongation legs 12 (cf. FIG. 2), when the screw 1 is in the screwed-in state.

FIG. 2 shows the connecting device 27 in a second preferred embodiment, the screw 1 being here in a state in which it has not yet been screwed in. The hollow space 8 has the same structural design as the hollow space shown in the first embodiment of the present invention and comprises an identically designed membrane 11, elongation legs 12 and projections 16. The statements made hereinbelow in connection with the hollow space 8, the membrane 11, the elongation legs 12 and the projections 16 thus refer to the first embodiment, shown in FIG. 1, as well as to the second embodiment, shown in FIG. 2. The difference between the second embodiment and the first embodiment is that the screw 1 is provided with a cutting edge 25 on a cutting tip 26 so as to allow a chip-removing engagement of the screw with the hollow space 8, the membrane 11, the elongation legs 12 and the projections 16.

The membrane is arranged substantially orthogonally to the sidewalls 10 of the hollow space and is provided with a centrally arranged notch 14, at the point where the longitudinal screw axis extends therethrough; said notch 14 can be provided at only one point or, in the form of a depression, along the whole longitudinal axis L of the profile section. Starting from the membrane 11, elongation legs 12 project, said elongation legs 12 substantially elongating the sidewalls 10 and their ends being provided with substantially orthogonally extending projections 16; in the screwed-in state of the screw 1, all these areas of the carrier 7 are in engagement with the thread 3 of said screw 1.

The sidewalls 10 of the hollow space 8 border on the bearing surface 17 of the carrier 7 substantially at right angles thereto. Prior to insertion of the screw 1, the hollow space 8 has a smallest diameter d, the term “diameter” referring here to the distance between the two parallel sidewalls 10. On a second side of its substantially square profile, the carrier 7 has a second hollow space 9 that is also provided with a membrane 11, elongation legs 12 and projections 16, which have substantially the same structural design as the corresponding, hitherto described areas of the first hollow space 8 of the carrier 7, but are arranged on a second side of the carrier 7 with an offset of 90°. Also the hollow space 9 can have inserted therein a screw 1 so as to fasten additional assembly parts.

FIG. 3 shows a screw 1 which is used in the connecting device according to the present invention. The screw 1 has a tool engagement portion 4, which can be provided in particular with a hexagonal profile or with arbitrary other tool engagement facilities known from the prior art. The tool engagement portion 4 is connected to a head rest portion 5 of the screw 1; the connection may be provided with a groove so that the tool engagement portion 4 can be sheared off more easily. When the screw 1 has been inserted in the connecting device, the head rest portion 5 of the screw 1 is in contact with the screw head contact surface 21 of the cover rail 18. The screw 1 comprises a thread 3 having an inner core diameter Di and an outer diameter Da. The distance d between the sidewalls of the hollow space 8, 9 is larger than the core diameter Di and smaller than the outer diameter Da of the screw 1. The individual thread convolutions have a flank angle β and the screw has a conical tip 6 with an angle α. The screw shown here is implemented as a forming screw so that it is able to form, without chip removal, a thread in the hollow space 8, 9, the membrane 11, the elongation legs 12 and the projections 16.

FIG. 8 shows a third embodiment of the present invention comprising a carrier 7 with a modified hollow space geometry, in which the distance between the sidewalls 30 is varied along the longitudinal direction Y of the screw screwed into the hollow space 28. The hollow space 28 has a smallest diameter/distance dₘᵢₙ, in the central area thereof and a larger diameter/distance dₘₐₓ₂ close to the membrane 11 in the boundary area thereof and a larger diameter/distance dₘₐₓ₁ close to the opening of the hollow space 28 on the outer side of the carrier 7. Analogously to the embodiment of FIG. 2, also a second hollow space 29 can be provided on the lateral side of the carrier 7, the structural design of said hollow space 29 corresponding largely to that of the hollow space 28. The constriction having the diameter/distance dₘᵢₙ can especially also be arranged a bit further down in the hollow spaces 28, 29 so as to allow a simpler and reliable initial grip of the screw 1 during screwing in.

FIGS. 4 to 7 show how the screw 1 is installed in the carrier 7 according to the connecting device of the first embodiment. First, the assembly parts 23, 24 are arranged on the bearing surface 17 of the carrier 7, whereupon the cover rail 18 is placed onto the assembly parts 23, 24 and the screw 1 is passed through the opening 19 of the cover rail 18 in such a way that it abuts on the walls of the hollow space 8 with a convolution of its thread 3.

Subsequently, the screw 1 is screwed in by means of a tool, which is not shown, until the condition shown in FIG. 5 is obtained, the torque remaining essentially the same until the screw tip 6 strikes against the membrane 11. Following this, the screw 1 is screwed in by the tool, which is not shown, until the condition shown in FIG. 6 is obtained, the membrane 11 being now deformed into a skirt 15 forming part of the thread convolutions 13 of the carrier 7. Finally, screwing-in of the screw is continued, with a now lower torque, until the condition shown in FIG. 7 is obtained, so that a force, which secures the assembly parts 23, 24 in position by means of frictional engagement, will become effective between the cover rail 18 and the bearing surface 17 of the carrier. When a certain torque is then still applied to the tool engagement portion 4 of the screw head 2 by means of a tool, which is not shown, the tool engagement portion 4 will shear off under the hitherto highest applied torque of the screw-in operation and the connecting device will then be in the condition shown in FIG. 1. Loosening the screw 1 is thus rendered more difficult and theft protection for the mounted assembly parts 23, 24 can be provided in this way.

FIG. 9 shows a carrier 70 for a fourth embodiment of the connecting device according to the present invention. In this embodiment, a screw-insertion channel 31, which also extends in the longitudinal direction of the carrier 70, is arranged above the hollow space 8. The screw-insertion channel 31 is provided with projections 32 at the upper end thereof, said projections 32 extending substantially transversely to the longitudinal screw axis. The projections 32 define in the carrier 70 an opening having a diameter d_{G} which is in particular larger than the diameter d of the hollow space. This will prevent screws which are inserted in the hollow space 8 from coming unintentionally into contact with the projections 32 of the screw-insertion channel 31. In order to allow the provision of a defined area of contact, the projections 32 are provided with the contact projections 33. The carrier 70 is additionally provided with a conventional screw-insertion channel 34 with projections 35.

As can be seen in FIG. 10, the additional screw-insertion channel 31 can have inserted therein a slot nut 36 provided with a thread 38 whereby conventional screws can be connected to said slot nut 36.

Hammer head screws 37 can be inserted with their head 40 into the screw-insertion channel 34. It is, however, also possible to insert the hammer head screws 37 into the screw-insertion channel 31.

The insertion of the hammer head screws 37 is shown in FIG. 11 by means of a top view of the carrier 70. The heads 40 of the hammer head screws have a chamfer 41 so as to allow the screws to be rotated in the screw-insertion channel 31, 34. The hammer head screws 39 are first arranged above the carrier 70 in such a way that the hammer head 40 extends parallel to the opening of the screw-insertion channel 31, whereby the head 40 can be moved into the screw-insertion channel 31. By rotating the hammer head screw 37, the head 40 is then caused to engage the projections 32. When the hammer head screw 37 has been rotated by 90°, the head 40 will abut on the sides of the screw-insertion channel 31 such that further rotation is no longer possible. The insertion of the hammer head screw 37 in the conventional screw-insertion channel 34 is executed in an identical manner.

A connection by means of the screw-insertion channel 31 has e.g. the advantage that, in areas where a more precise alignment of the connection is required, a conventional screw in combination with the slot nut 36 or the hammer head screw 37 is used. In areas where fast screwing in of the screw is important, screws can be screwed directly into the hollow space 8. Areas requiring higher precision are e.g. the first few metres of a field used for fastening solar modules, since a very precise alignment of the solar modules will there be necessary.

The screw-insertion channel is arranged above the hollow space in such a way that the connection according to the present invention can be established by screwing a screw into the hollow space as well as by inserting a screw or a slot nut into the screw-insertion channel; it will be of advantage when screws inserted in the screw-insertion channel and in the hollow space extend in parallel.

The method for creating a connecting device comprises substantially the following steps:
(i) orienting a screw 1 above a carrier 7 so that the longitudinal screw axis Y is directed towards a hollow space 8 of the carrier 7,
(ii) screwing the screw 1 into the hollow space 8 up to a membrane 11, the thread 3 of the screw 1 being in engagement with the carrier 7 in the hollow space 8 of the latter,
(iii) continuing the screwing in of the screw 1, so that the screw 1 will penetrate the membrane 11, and
(iv) screwing in the screw 1 until it has reached the end position at which the screw head 2 of the screw 1 abuts, indirectly or directly, on the carrier 7 or on an assembly part 23, 24.

Furthermore, the grip of the screw 1 in the carrier 7 can be created, during screwing in step (ii), by plastically deforming the hollow space 8 by means of the screw 1.

Alternatively, the grip of the screw 1 in the carrier 7 can be created, during screwing in step (ii), by a chip-removing action of the screw 1 in the hollow space 8.

The penetration of the screw 1 through the membrane 11 can be created by a plastic deformation of said membrane 11 caused by the screw 1 during screwing in step (iii).

In the course of this process, the membrane 11 is displaced as a flow material by the screw 1 upwards/downwards, where it is supported by the sidewalls 10 of the hollow space 8, 9 and/or the elongation legs 12 thus forming a part of the thread convolutions 13 of the hollow space 8, 9 which is in close contact with the screw 1.

The screwing in step (iv) may additionally comprise the especially forming engagement of the screw 1 with at least one elongation leg 12 extending after the membrane 11 substantially in the longitudinal direction Y of the screw.

In addition, the screwing in step (iv) may also comprise the especially forming engagement of the screw 1 with at least one projection 16 protruding from the elongation leg 12 towards the screw 1 substantially orthogonally to the longitudinal direction Y of the screw.

The screwing-in torque can be applied to a tool engagement portion 4 of the screw head 2, and the method can be followed by step (v), which comprises the application of a torque to the tool engagement portion 4 so that the tool engagement portion 4 will shear off from a head rest portion 5 of the screw head 2.

1. A connecting device, comprising
a screw having a longitudinal axis and
a carrier, said carrier being provided with a hollow space for receiving therein said screw, said hollow space being in frictional and/or positive engagement with the thread of the screw upon insertion of said screw, wherein the hollow space is provided with a membrane penetratable by the screw and which is arranged substantially transversely to the longitudinal screw axis, said membrane forming a skirt, which encloses primarily the thread at least partially, while undergoing deformation during insertion of the screw.

2. A connecting device according to claim 1, wherein that the carrier comprises a preferably planar bearing surface which is arranged substantially at right angles to the longitudinal screw axis, the screw and/or at least one assembly part being in contact with the bearing surface, and that the hollow space opens into the bearing surface.

3. A connecting device according to claim 1, wherein the diameter of the hollow space is varied along the longitudinal screw axis such that said hollow space has a largest diameter at the membrane on the side of the hollow space from which the screw is inserted and the smallest diameter between these areas.

4. A connecting device according to claim 1, wherein when seen at right angles to the longitudinal screw axis, the smallest diameter of the hollow space is smaller than the outer diameter of the thread.

5. A connecting device according to claim 1, wherein when seen at right angles to the longitudinal screw axis, a smallest diameter of the hollow space is larger than a core diameter of the thread.

6. A connecting device according to claim 1, wherein the carrier is implemented as a profile section, made especially of light metal, and that the hollow space defines within the carrier a channel in the longitudinal direction of the profile section.

7. A connecting device according to claim 1, wherein the hollow space comprises at least two sidewalls and the membrane connects said sidewalls.

8. A connecting device according to claim 7, wherein the sidewalls are spaced apart substantially at a distance.

9. A connecting device according to claim 7, wherein the sidewalls are spaced apart at a larger distance (dₘₐₓ₁, dₘₐₓ₂) in the upper area of the hollow space and in the lower area of said hollow space, and at a minimum distance (dₘᵢₙ) in an area therebetween.

10. A connecting device according to claim 1, wherein the carrier has a rectangular profile cross-section at least in the area of the connecting device.

11. A connecting device according to claim 1, wherein the carrier comprises a plurality of hollow spaces, which are preferably arranged orthogonally to one another.

12. A connecting device according to claim 1, wherein the material used for the screw has a higher strength than the material used for the carrier.

13. A connecting device according to claim 1, wherein the screw has a tip has in a shape causing a uniform deformation resistance upon being driven through the membrane.

14. A connecting device according to claim 13, wherein the thread at the screw tip is conical in shape.

15. A connecting device according to claim 1, wherein the screw is a self-tapping screw, and is provided with a forming tip.

16. A connecting device according to claim 1, wherein the screw is provided with a cutting tip.

17. A connecting device according to claim 16, wherein the screw has a cutting edge on its cutting tip, said cutting edge extending from the tip up to and into a cylindrical portion of the screw and being in particular provided with an adjoining recess for receiving therein chips.

18. A connecting device according to claim 1, wherein at least one elongation leg projects beyond the membrane substantially in the direction of the longitudinal screw axis downwards on one side.

19. A connecting device according to claim 18, wherein the elongation leg has on its end at least one projection directed substantially towards the longitudinal screw axis.

20. A connecting device according to claim 19, wherein the projection is arranged substantially in the plane extending at right angles to the longitudinal screw axis.

21. A connecting device according to claim 18, wherein each of two elongation legs is provided with a projection, said projections being arranged substantially in opposed relationship with each other.

22. A connecting device according to claim 18, wherein a respective elongation leg is provided with a plurality of projections.

23. A connecting device according to claim 18, wherein an elongation leg at least partially encloses the skirt.

24. A connecting device according to claim 18, wherein an elongation leg is in engagement with the thread of the screw.

25. A connecting device according to claim 1, wherein an inserted condition of the screw, the thread is located at least on level with the membrane.

26. A connecting device according to claim 1, wherein upon insertion of the screw, the hollow space is deformed such that it forms thread convolutions for the screw.

27. A connecting device according to claim 1, wherein prior to undergoing deformation, the membrane is substantially flat.

28. A connecting device according to claim 1, wherein the membrane is substantially funnel shaped prior to undergoing deformation in the section penetrated by the screw.

29. A connecting device according to claim 1, wherein prior to being deformed by the screw, the membrane has a reduced thickness, in particular a notch, at least one location thereof.

30. A connecting device of claim 29, wherein said membrane has a notch.

31. A connecting device according to claim 1, wherein prior to being deformed by the screw, the membrane is provided with an opening in at least one location thereof.

32. A connecting device of claim 31, wherein said opening is a longitudinal cut.

33. A connecting device according to claim 1, wherein at least one assembly part is in engagement with a screw head of the screw and the carrier.

34. A connecting device according to claim 33, where the assembly is indirect engagment with the screw head.

35. A connecting device according to claim 1, wherein a screw-insertion channel is arranged in the carrier above the hollow space, said screw-insertion channel being provided with projections defining an opening having a diameter which is larger than the diameter of the hollow space.

36. A connecting device according to claim 33, wherein the screw-insertion channel is implemented such that a slot nut can be arranged therein, said slot nut having a thread for screwing in a screw.

37. A connecting device according to claim 33, wherein the screw-insertion channel is implemented such that the head of a screw can be arranged therein, the thread of the screw projecting beyond the carrier.

38. A method for creating a screw connection, comprising:
(i) orienting a screw above a carrier so that the longitudinal screw axis is directed towards a hollow space of the carrier,
(ii) screwing the screw into the hollow space up to a membrane, the screw having thread, said thread of the screw being in engagement with the carrier in the hollow space of the latter,
(iii) continuing the screwing in of the screw, so that the screw will penetrate the membrane, and
(iv) screwing in the screw until it has reached an end position at which a screw head of the screw abuts, indirectly or directly, on the carrier or on an assembly part.

39. A method according to claim 36, wherein the engagement of the screw in the carrier is created, during screwing in by plastically deforming the hollow space by means of the screw.

40. A method according to claim 36, wherein the engagement of the screw in the carrier is created, during screwing by a chip-removing action of the screw in the hollow space.

41. A method according to claim 36, wherein penetration of the screw through the membrane is created by a plastic deformation of said membrane caused by the screw during screwing.

42. A method according to claim 39, wherein the membrane is displaced as a flow material by the screw upwards/downwards, where it is supported by sidewalls of the hollow space and/or by elongation legs thus forming a part of the thread convolutions of the hollow space which is in close contact with the screw.

43. A method according to one of the claims 36, wherein the screwing additionally comprises the especially forming engagement of the screw with at least one elongation leg extending after the membrane substantially in the longitudinal direction of the screw.

44. A method according to claim 41, wherein the screwing additionally comprises forming engagement of the screw with at least one projection protruding from the elongation leg towards the screw substantially orthogonally to the longitudinal direction of the screw.

45. A method according to claim 36, wherein the screwing-in torque is applied to a tool engagement portion of the screw head, and that the additional step (v), which comprises the application of a torque to the tool engagement portion so that the tool engagement portion will shear off from a head rest portion of the screw head, is subsequently executed.
